(19) United States
(12) Patent Application Publication
(10) Pub. No.: US 2017/0238175 A1
(43) Pub. Date: Aug. 17, 2017

(54) TRANSMISSION DEVICE, COMMUNICATION SYSTEM, AND AUTHENTICATION INFORMATION TRANSMISSION METHOD

(71) Applicant: Alps Electric Co., Ltd., Tokyo (JP)

(72) Inventor: Akira MIYAZAWA, Miyagi-ken (JP)

(21) Appl. No.: 15/346,303

(22) Filed: Nov. 8, 2016

(30) Foreign Application Priority Data
Feb. 15, 2016 (JP) 2016-026286

(51) Int. Cl. H04W 12/06; H04W 12/08

(52) U.S. Cl. CPC H04W 12/06; H04W 12/08

(57) ABSTRACT

A transmission device includes a transmission-side code selection unit that sequentially selects one code from a predetermined code sequence each time authentication information including an authentication code is transmitted to a control device, an authentication information generation unit that generates the authentication information including a code that is being selected in the transmission-side code selection unit, a transmission unit that wirelessly transmits the generated authentication information, and a control unit that outputs, from the transmission unit, interference waves that interfere with reception of the authentication information in the control device in a period of at least a portion of an interval period from transmission of one piece of authentication information to transmission of next authentication information.

### CLAIM OF PRIORITY

This application claims the benefit of Japanese Patent Application No. 2016-026286 filed on Feb. 15, 2016, which is hereby incorporated by reference.

### BACKGROUND OF THE INVENTION

### 1. Field of the Invention

The present invention relates to a transmission device that wirelessly transmits authentication information to an authentication request destination, a communication system, and an authentication information transmission method and, for example, to a transmission device that is used for a keyless entry system that performs control such as unlocking of a door by transmitting authentication information to a control device mounted on a vehicle.

### 2. Description of the Related Art

A keyless entry system in which a vehicle operation such as locking or unlocking of a door of a vehicle, or startup of an engine is performed on the basis of wireless communication between a vehicle-mounted control device and a portable device is known. Japanese Unexamined Patent Application Publication No. 7-32975 below discloses a keyless entry system in which authentication information (a fixed number and a code number) for lock release is transmitted from a portable device (transmitter) to a vehicle-mounted control device (lock releasing device) using a “rolling code scheme”.

In a rolling code scheme, authentication information is generated using a code that is changed each time authentication information is transmitted. Therefore, even when it was possible to intercept communication between the portable device and the vehicle-mounted control device and acquire the authentication information, it is not possible to pass the authentication of the vehicle-mounted control device using this as it is. That is, since the authentication information obtained through interception of communication has already passed the authentication in the vehicle-mounted control device, the authentication information cannot be used from the next authentication.

However, when the authentication information is acquired through interception of the communication, authentication of the authentication information in the vehicle-mounted control device can be prevented from passing in some cases. For example, there is a method of blocking reception of the authentication information in a vehicle-mounted control device using interference waves simultaneously while intercepting authentication information transmitted from a portable device.

Generally, a reception frequency band of a vehicle-mounted control device is set to be wider than a transmission frequency band of actual authentication information in consideration of individual variations or temperature variation of a product. Therefore, in some cases, only the authentication information can be received using a band pass filter for a narrow band or the like while reception of the authentication information in the vehicle-mounted control device is being blocked by generating interference waves in a reception frequency band and outside of the transmission frequency band. Since the authentication information fraudulently acquired using such a method is regular authentication information that has not yet been received in a vehicle-mounted control device, authentication can be passed by retransmitting the authentication information to the vehicle-mounted control device.

### SUMMARY OF THE INVENTION

The present invention provides a transmission device capable of enabling fraudulent acquisition of authentication information to be easily discovered, a communication system, and an authentication information transmission method.

A transmission device according to a first aspect of the present invention is a transmission device that wirelessly transmits authentication information including a code for authentication to an authentication request destination, the transmission device including: a transmission-side code selection unit configured to sequentially select one code from a predetermined code sequence each time the authentication information is transmitted; an authentication information generation unit configured to generate the authentication information including a code that is being selected in the transmission-side code selection unit; a transmission unit configured to wirelessly transmit the generated authentication information; and a control unit configured to output, from the transmission unit, interference waves that interfere with reception of the authentication information in the authentication request destination in a period of at least a portion of an interval period from transmission of one piece of authentication information to transmission of next authentication information.

In a case where the authentication code is a code that is sequentially selected from the predetermined code sequence each time the authentication information is transmitted, it is not possible to pass the authentication of the authentication request destination using the intercepted authentication information even when the authentication information is simply intercepted. However, in the case of fraudulently acquiring the authentication information while interfering with the reception in the authentication request destination, the fraudulently acquired authentication information has not been yet received in the authentication request destination. Accordingly, it is possible to pass the authentication in the authentication request destination by retransmitting the fraudulently acquired authentication information to the authentication request destination. Therefore, in the case of fraudulently acquiring a plurality of pieces of authentication information continuously transmitted from the transmission unit while interfering with the reception in the authentication request destination, if first authentication information in the plurality of fraudulently acquired pieces of authentication information is retransmitted to the authentication request destination, the authentication is passed using the retransmitted authentication information in the authentication request destination, and it is difficult for the fraudulent acquisition of the authentication information to be found. According to the above configuration, since the interference waves interfere with the reception of the authentication information in the authentication request destination in a period of at least a portion of an interval period from transmission of authentication information to next transmission of the authentication information, it is difficult for the authentication information retransmitted after the fraudulent acquisition to be received in the authentication request destination. Accordingly, since the authentication in the authentication request destination is not passed even though a plurality of pieces of authentication information are transmitted, it is possible to easily discover the fraudulent acquisition of the authentication information.

Preferably, the control unit may output the interference waves from the transmission unit in at least one of a certain period before the authentication information is transmitted and a certain period after the authentication information is transmitted.

According to the above configuration, since the output of the interference waves is performed in a certain period, power is not normally consumed due to the output of the interference waves.

Preferably, the control unit may transmit dummy authentication information that is able to be received as the authentication information in the authentication request destination and that is determined to be not legitimate, from the transmission unit in a period of at least a portion of the interval period.

According to the above configuration, it is difficult for regular authentication information retransmitted after fraudulent acquisition to be received in the authentication request destination due to the transmission of the dummy authentication information in the interval period. That is, the dummy authentication information functions as interference waves. Therefore, it is easy for a state in which the authentication in the authentication request destination is not passed to continue, and the fraudulent acquisition of the authentication information is easily discovered. Further, since the authentication of the authentication request destination cannot be passed with the dummy authentication information even when the dummy authentication information is fraudulently acquired, security is improved.

Preferably, the control unit may change at least one of the number of transmissions, a transmission interval, and a transmission period of the dummy authentication information in the interval period, in each interval period.

According to the above configuration, since it is difficult to distinguish between regular authentication information and the dummy authentication information, the dummy authentication information is fraudulently acquired in place of the regular authentication information, and a probability of retransmission becomes high. Accordingly, it is easy for a state in which the authentication in the authentication request destination is not passed to continue, and the fraudulent acquisition of the authentication information is easily discovered.

A communication system according to a second aspect of the present invention includes: a transmission device configured to wirelessly transmit authentication information including a code for authentication, and a control device configured to receive the authentication information and determine legitimacy of the received authentication information, in which the transmission device includes a transmission-side code selection unit configured to sequentially select one code from a predetermined code sequence each time the authentication information is transmitted; an authentication information generation unit configured to generate the authentication information including a code that is being selected in the transmission-side code selection unit; a transmission unit configured to wirelessly transmit the generated authentication information; and a control unit configured to output, from the transmission unit, interference waves that interfere with reception of the authentication information in the control device in a period of at least a portion of an interval period from transmission of one piece of authentication information to transmission of next authentication information.

According to the above configuration, since the interference waves interfere with the reception of the authentication information in the control device in a period of at least a portion of an interval period from transmission of authentication information to next transmission of the authentication information, it is difficult for the authentication information retransmitted after the fraudulent acquisition to be received in the control device. Accordingly, since the authentication in the control device is not passed even though a plurality of pieces of authentication information are transmitted, it is possible to easily discover the fraudulent acquisition of the authentication information.

A communication method according to a third aspect of the present invention is an authentication information transmission method in which a transmission device wirelessly transmits authentication information including a code for authentication to an authentication request destination, the method including: sequentially selecting one code from a predetermined code sequence each time the authentication information is transmitted; generating the authentication information including a code that is being selected through the code selection; wirelessly transmitting the generated authentication information; and transmitting interference waves that interfere with reception of the authentication information in the authentication request destination in a period of at least a portion of an interval period from transmission of one piece of authentication information to transmission of next authentication information.

According to the above configuration, since the interference waves interfere with the reception of the authentication information in the authentication request destination in a period of at least a portion of an interval period from transmission of authentication information to next transmission of the authentication information, it is difficult for the authentication information retransmitted after the fraudulent acquisition to be received in the authentication request destination. Accordingly, since the authentication in the authentication request destination is not passed even though a plurality of pieces of authentication information are transmitted, the fraudulent acquisition of the authentication information is easily discovered.

According to the present invention, it is possible to easily discover the fraudulent acquisition of the authentication information.

### BRIEF DESCRIPTION OF THE DRAWINGS

FIG. 1 is a first diagram illustrating an example of a configuration of a communication system according to an embodiment of the present invention.

FIG. 2 is a second diagram illustrating an example of a configuration of a communication system according to an embodiment of the present invention.

FIG. 3 is a diagram illustrating an example in which interception and reception interference of authentication information are performed by a fraudulent unlock device.

FIG. 4 is a diagram illustrating a comparative example illustrating an attack of a fraudulent unlock device.

FIG. 5 is a diagram illustrating an example of an operation in a case where authentication information is transmitted from a transmission device in a communication system according to an embodiment of the present invention.

FIG. 6 is a diagram illustrating a modification example of the operation in a case where authentication information is transmitted from a transmission device in a communication system according to an embodiment of the present invention.

FIGS. 7A to 7C are diagrams illustrating another modification example of the operation in a case where authentication information is transmitted from a transmission device.

### DESCRIPTION OF THE PREFERRED EMBODIMENTS

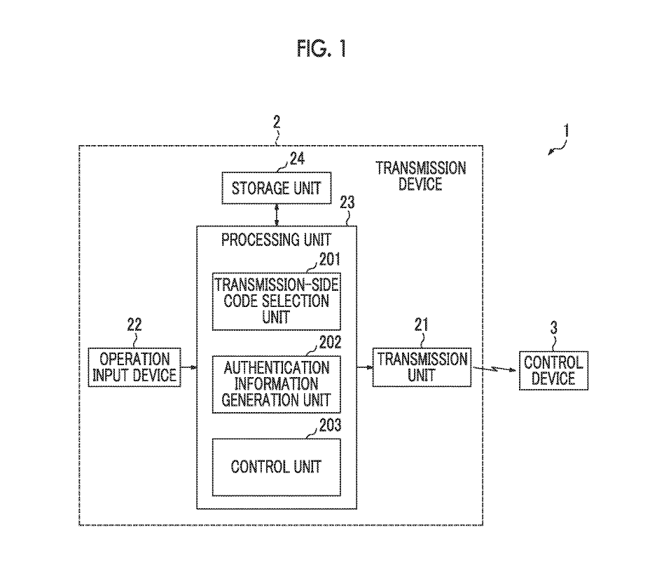

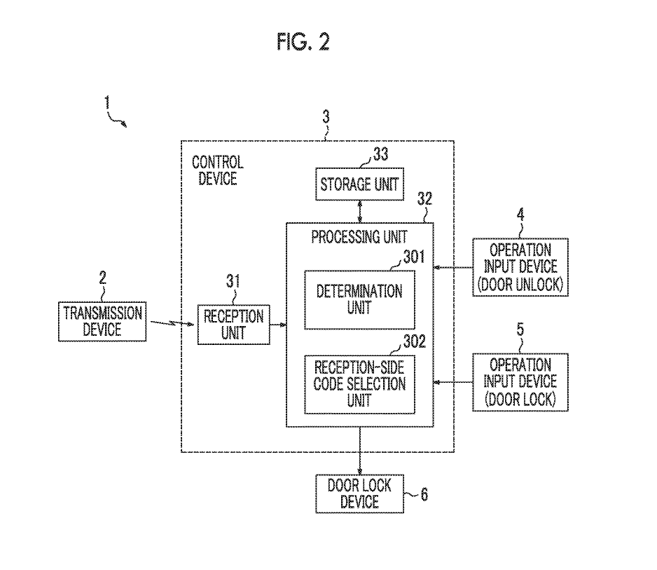

FIGS. 1 and 2 are diagrams illustrating an example of a configuration of a communication system 1 according to an embodiment of the present invention. The communication system 1 illustrated in FIG. 1 is, for example, a keyless entry system that controls release of doors in a vehicle through wireless remote control, and includes a transmission device 2 that can be carried by a user as a portable device, and a control device 3 mounted on the vehicle or the like.

### Transmission Device 2

In the example of FIG. 1, the transmission device 2 includes a transmission unit 21, an operation input device 22, a processing unit 23, and a storage unit 24.

The transmission unit 21 wirelessly transmits authentication information generated in the processing unit 23 to the control device 3. That is, the transmission unit 21 performs predetermined signal processing such as coding, modulation, and amplification on data including the authentication information generated in the processing unit 23 to generate a transmission signal of a predetermined communication scheme, and transmits the transmission signal as a radio signal from an antenna (not illustrated).

The operation input device 22 is a device that generates a signal according to a predetermined operation of the user and is configured with, for example, a button or a touch sensor.

The processing unit 23 is a circuit that performs overall control of the transmission device 2 and is configured, for example, with a computer (for example, a microprocessor) that executes instructions on the basis of a program stored in the storage unit 24, or a dedicated logic circuit (ASIC).

When a signal according to a predetermined operation for instructing transmission of the authentication information is generated in the operation input device 22, the processing unit 23 generates the authentication information on the basis of the data stored in the storage unit 24, and transmits the authentication information as a radio signal from the transmission unit 21.

The processing unit 23 is a processing block that executes a predetermined process, and includes a transmission-side code selection unit 201, an authentication information generation unit 202, and control unit 203.

The transmission-side code selection unit 201 sequentially selects one code from a predetermined code sequence each time the authentication information is transmitted from the transmission unit 21. The “Predetermined code sequence” includes a plurality of codes arranged in determined order. It is preferable for all the plurality of codes to be different codes. In one example, the “predetermined code sequence” is a sequence of numerical values that are sequentially changed according to a predetermined rule (for example, are incremented by 1), and each numerical value indicates one code. In another example, the “predetermined code sequence” may be a sequence of numerical values that have no regularity. The transmission-side code selection unit 201 selects the code one by one from the “predetermined code sequence” in each transmission of the authentication information according to an order of the sequence of the codes in the “predetermined code sequence”.

In the following description, for example, it is assumed that each code of the “predetermined code sequence” is a natural numerical value, and each code has a value greater by 1 than that of a code having an order earlier by 1. That is, the “predetermined code sequence” has a code value increased by 1 when the order goes ahead by 1. The transmission-side code selection unit 201 can select the code in any order in the “predetermined code sequence” by adding or subtracting any numerical value to or from the code that is being selected. For example, in a case where the code that is being selected is “K”, if the authentication information is transmitted once from the transmission unit 21, the transmission-side code selection unit 201 newly selects “K+1” obtained by adding 1 to the code “K” that is being selected.

The authentication information generation unit 202 generates authentication information including the code that is being selected in the transmission-side code selection unit 201. For example, in addition to the code that is being selected described above, identification information for identifying the control device 3 that is a transmission destination from other devices (identification information of the transmission destination) or identification information for identifying the transmission device 2 itself from other devices (identification information of the transmission source) is included in the authentication information. The authentication information generation unit 202 generates authentication information that includes such information and is encrypted.

The control unit 203 outputs, from the transmission unit 21, interference waves that interfere with reception of the authentication information in the control device 3 that is an authentication request destination in a period of at least a portion of an interval period from transmission of one piece of authentication information in the transmission unit 21 to transmission of the next authentication information. For example, the control unit 203 outputs the interference waves from the transmission unit 21 in at least one of a certain period before the authentication information is transmitted and a certain period after the authentication information is transmitted.

The storage unit 24 is, for example, a device that stores a computer program in the processing unit 23, data prepared for processing (for example, identification information of a device included in the authentication information, and key information for encryption of the authentication information), and data temporarily stored in a process (for example, a code that is being selected in the transmission-side code selection unit 201), and includes a RAM, a non-volatile memory, or a hard disk. The program or the data stored in the storage unit 24 may be downloaded from an external device via an interface device (not illustrated) or may be read from a non-transitory recording medium such as an optical disk or a USB memory.

### Control Device 3

The control device 3 is a device that controls various devices in the vehicle, and controls a door lock device 6 that locks and unlocks the doors in the example of FIG. 2. When the control device 3 receives the authentication information from the transmission device 2, the control device 3 determines legitimacy of the authentication information, and in a case where the control device 3 determines that the authentication information is legitimate, the control device 3 controls the door lock device 6 so that the door lock device 6 performs the unlocking or locking of the door. Further, the control device 3 controls the door lock device 6 so that the door lock device 6 performs unlocking and locking of the door according to an operation of the operation input devices 4 and 5 such as a switch, a button, or a touch sensor provided in the vehicle.

In the example of FIG. 2, the control device 3 includes a reception unit 31, a processing unit 32, and a storage unit 33.

The reception unit 31 receives the authentication information that is wirelessly transmitted from the transmission device 2. That is, the reception unit 31 performs predetermined signal processing such as amplification, demodulation, and decoding on a radio signal received in an antenna (not illustrated) to generate reception data, and outputs the reception data to the processing unit 32.

The processing unit 32 is a circuit that performs overall control of the control device 3 and includes, for example, a computer (for example, a microprocessor) that executes an instruction on the basis of a program stored in the storage unit 33 or a dedicated logic circuit (for example, ASIC).

The processing unit 32 is a processing block that executes a predetermined process, and includes a determination unit 301, and a reception-side code selection unit 302.

In a case where the authentication information received in the reception unit 31 is determined to be legitimate in the determination unit 301 to be described below, the reception-side code selection unit 302 selects a next code in the “predetermined code sequence” with respect to code included in the authentication information determined to be legitimate. The “predetermined code sequence” of the reception-side code selection unit 302 is the same as the transmission-side code selection unit 201. For example, in a case where the “predetermined code sequence” is a sequence of numerical values that are progressive by 1 as “1”, “2”, “3”, . . . and the code included in the authentication information determined to be legitimate in the determination unit 301 is “K”, the reception-side code selection unit 302 newly selects “K+1” obtained by adding 1 to the code.
1. When the authentication information is normally received in the reception unit 31, the determination unit 301 decodes respective encrypted pieces of information (for example, transmission source identification information, transmission destination identification information, and the code selected in the transmission-side code selection unit 201) included in the received authentication information. The determination unit 301 determines the legitimacy of the received authentication information on the basis of the decoded information and the code that is being selected in the reception-side code selection unit 302.

The determination unit 301 collates the identification information of the transmission destination and the identification information of the transmission source included in the received authentication information with identification information stored in the storage unit 33. That is, the determination unit 301 checks whether or not the authentication information has been transmitted to the own device by collating the identification information of the transmission destination included in the received authentication information with the identification information of the own device (control device 3) stored in the storage unit 33. Further, the determination unit 301 checks whether or not the transmission device 2 that is the transmission source has been registered in advance by collating the identification information of the transmission source included in the received authentication information with the identification information of the transmission source stored in the storage unit 33. The determination unit 301 sets match of the identification information of the transmission destination and the identification information of the transmission source included in the received authentication information with the identification information stored in the storage unit 33 as one of conditions of the legitimacy of the authentication information. Hereinafter, this is referred to as a “first condition”.

Further, the determination unit 301 checks whether the code included in the authentication information received by the reception unit 31 and the code that is being selected in the reception-side code selection unit 302 satisfies a predetermined relationship. The determination unit 301 sets that the code included in the authentication information and the code that is being selected satisfying the predetermined relationship on the basis of this check, as one of conditions of the legitimacy of the authentication information. Hereinafter, this is referred to as a “second condition”.

For example, the determination unit 301 checks whether the code included in the received authentication information belongs to a partial code sequence having a predetermined length included in the “predetermined code sequence”. A code at a head of the partial code sequence is a code that is being selected in the reception-side code selection unit 302. Specifically, for example, when the code that is being selected in the reception-side code selection unit 303 is “K” and a code length of the partial code sequence is “α+1” (a is a natural number greater than 1), the partial code sequence is “K”, “K+1”, . . . , a “K+α”. If the code included in the received authentication information is “K+β” (0≦β≦α), the determination unit 301 determines that the “second condition” is satisfied, and otherwise, determines that the “second condition” is not satisfied.

In a case where the code included in the received authentication information matches a code progressing ahead of the code at a head of the partial code sequence (0<β≦α in the above example), the code that is being selected in the transmission-side code selection unit 201 progresses ahead of the code that is being selected in the reception-side code selection unit 302, for example, due to transmission of the authentication information from the transmission device 2 at a place remote from the control device 3.

In a case where the received authentication information does not satisfy the “first condition” or the “second condition”, the determination unit 301 determines that this authentication information is not legitimate. In a case where the received authentication information satisfies both of the “first condition” and the “second condition”, the determination unit 301 determines that this authentication information is legitimate.

The storage unit 33 is, for example, a device that stores a computer program in the processing unit 32, data prepared for processing (for example, identification information of a device used for collation of the authentication information, and key information for encryption of the authentication information), and data temporarily stored in a process (for example, a code that is being selected in the reception-side code selection unit 302), and includes a RAM, a non-volatile memory, or a hard disk. The program or the data stored in the storage unit 33 may be downloaded from an external device via an interface device (not illustrated) or may be read from a non-transitory recording medium such as an optical disk or a USB memory.

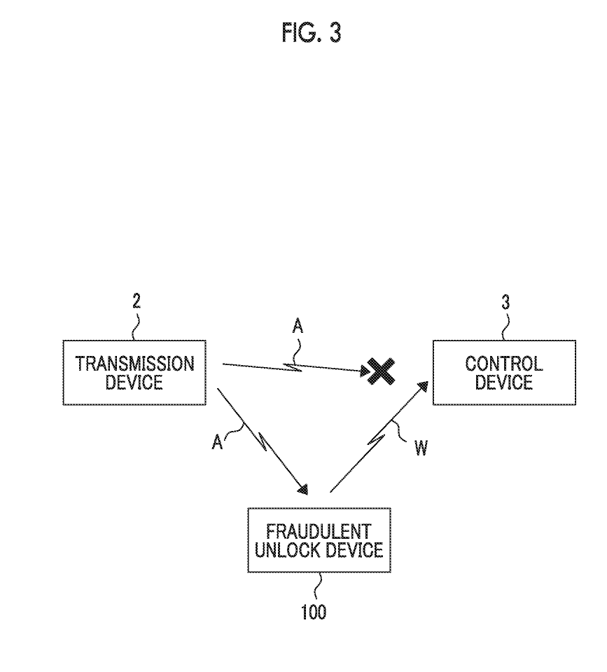

A method of determining the authentication information in the communication system 1 having the above configuration will be described herein with reference to FIGS. 3 to 5.

Next, an operation in a case where an attack that attempts to pass authentication of the control device 3 using fraudulently acquired authentication information is performed will be described.

FIG. 3 is a diagram illustrating an example in which interception and reception interference of authentication information are performed by the fraudulent unlock device 100. The fraudulent unlock device 100 is disposed in a position in which the fraudulent unlock device 100 is able to intercept the authentication information A transmitted from the transmission device 2 and is able to transmit interference waves W to the control device 3. When the fraudulent unlock device 100 detects that the authentication information A is transmitted from the transmission device 2, the fraudulent unlock device 100 outputs the interference waves W to the control device 3 to block the authentication information A being received by the control device 3, removes the interference waves W using a band pass filter or the like to acquire the authentication information A.

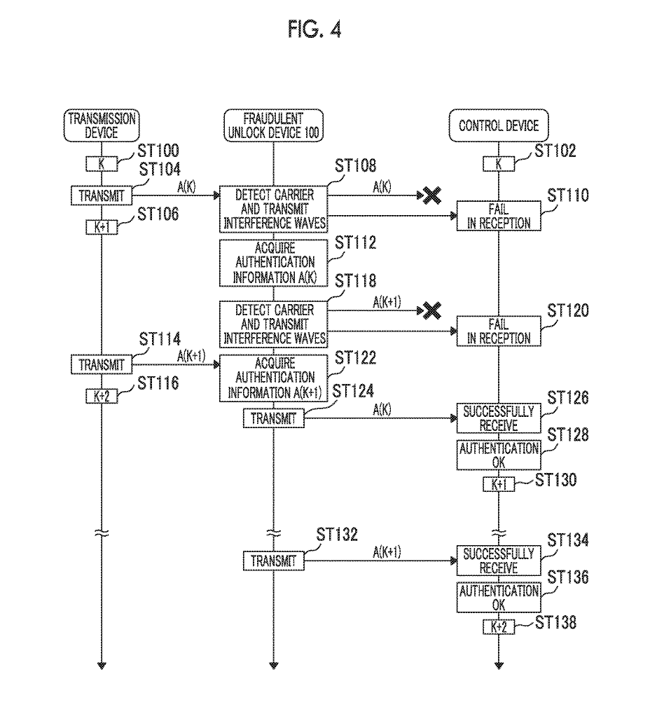

FIG. 4 is a diagram illustrating a comparative example illustrating an attack of the fraudulent unlock device 100.

In each drawing subsequent to FIG. 3, reference sign “A” indicates authentication information. Further, a reference sign in parentheses added to reference sign “A” indicates a code included in the authentication information. Further, in the following description of an example of an operation, it is assumed that identification information of a transmission source and identification information of a transmission destination included in the authentication information generated by the transmission device 2 match identification information held in the storage unit 33 of the control device 3, unless otherwise specified. That is, the above-described “first condition” is assumed to be always satisfied at the time of the determination of the determination unit 301.

First, both of the transmission device and the control device select the code “K” (ST100 and ST102). When the transmission device transmits the authentication information A(K) including the code “K”, the transmission device selects the next code “K+1” (ST104 and ST106). When the fraudulent unlock device 100 detects that the authentication information A(K) is transmitted from the transmission device using a carrier or the like of a transmission signal, the fraudulent unlock device 100 outputs interference waves W toward the control device (ST108). As a result, the control device fails in reception of the authentication information A(K) (ST110). The fraudulent unlock device 100 removes the interference waves W using a band-pass filter or the like to acquire the authentication information A(K) (ST112).

When the control device fails in reception of the authentication information A(K), predetermined control (for example, unlocking of a door) is not performed in the control device. Therefore, a transmission operation is performed by the user again, and the next authentication information A(K+1) is transmitted from the transmission device (ST114). In this case, the code included in the authentication information A(K+1) is “K+1”. The fraudulent unlock device 100 also interfere with the reception of the authentication information A(K+1) (ST118 and ST120) to acquire the authentication information A(K+1) including the code “K+1” (ST122). When the fraudulent unlock device 100 acquires the authentication information A(K+1), the fraudulent unlock device 100 immediately retransmits the authentication information A(K) acquired in step ST112 to the control device (ST124). In this case, since the fraudulent unlock device 100 does not output the interference waves, the control device successfully receives the authentication information A(K) (ST126). Since the authentication information A(K) acquired in step ST112 includes the code “K” and the code matches the code “K” that is being selected by the control device, the control device determines that this authentication information A(K) is legitimate (ST128). Accordingly, the control device executes predetermined control such as door unlocking. The control device selects the next code “K+1” by authenticating the authentication information A including the code “K” (ST130). The user misunderstands that control such as door unlocking has been executed by a transmission operation in step ST 114 and does not notice presence of fraudulent unlock device 100.

Thereafter, the fraudulent unlock device 100 retransmits the authentication information A(K+1) acquired in step ST122 to the control device (ST132). When the control device receives the retransmitted authentication information A(K+1) (ST134), the control device determines that the authentication information A(K+1) is legitimate since the code “K+1” included in the authentication information A(K+1) matches the code “K+1” that is being selected (ST136).

Thus, the fraudulent unlock device 100 successfully passes the authentication of the control device using the fraudulently acquired authentication information A(K+1).

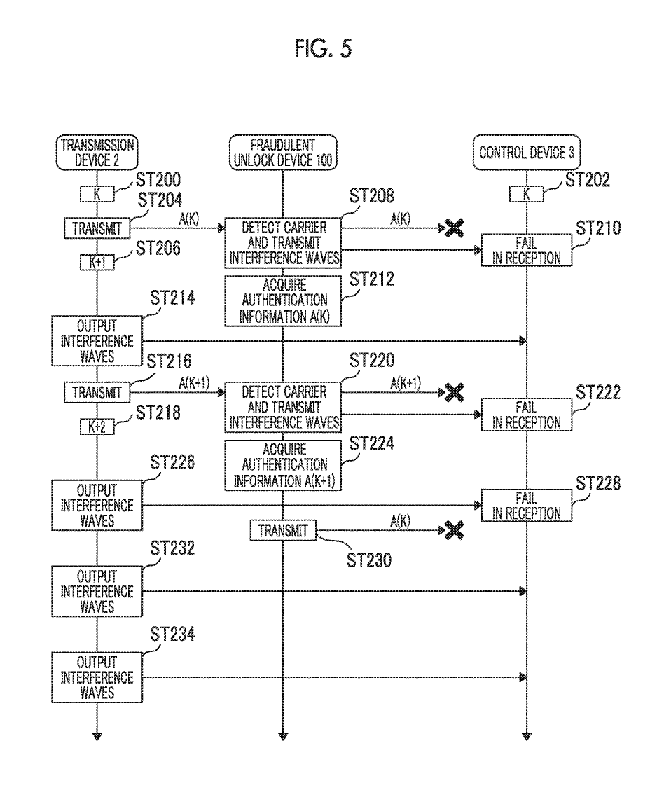

FIG. 5 is a diagram illustrating an example of an operation in a case where the authentication information is transmitted from transmission device 2 in the communication system 1 according to an embodiment of the present invention.

First, both the transmission-side code selection unit 201 and the reception-side code selection unit 302 select the code “K” (ST200 and ST202). In this state, the transmission device 2 transmits the authentication information A (ST204). The transmission-side code selection unit 201 changes a selection target code from “K” to “K+1” (ST206).

When the fraudulent unlock device 100 detects that the authentication information is transmitted from the transmission device 2 using a carrier or the like of a transmission signal, the fraudulent unlock device 100 outputs interference waves W toward the control device 3 (ST208). Accordingly, the control device 3 fails reception of the authentication information A(K) (ST210). The fraudulent unlock device 100 removes the interference waves W using a band-pass filter or the like, and acquires the authentication information A(K) (ST212).

The control unit 203 outputs the interference waves from the transmission unit 21 in an interval period until next authentication information A(K+1) is transmitted after the authentication information A(K) is transmitted from the transmission unit 21 in step ST204 (ST214).

When the control device 3 fails in reception of the authentication information A(K), the authentication information A(K+1) is retransmitted from the transmission unit 21 by a re-transmission operation of the user (ST216). Through this transmission, the transmission-side code selection unit 201 selects the next code “K+2” (ST218).

The control unit 203 repeatedly outputs the interference waves from the transmission unit 21 in an interval period until next authentication information A(K+2) is transmitted after the authentication information A(K+1) is transmitted from the transmission unit 21 in step ST216 (ST226, ST232, and ST234). For example, the control unit 203 periodically repeats the output of the interference waves from the transmission unit 21 during a certain period from the transmission of the authentication information in the transmission unit 21.

On the other hand, the fraudulent unlock device 100 interferes with the transmission of the authentication information A(K+1) (ST220 and ST222), and acquires the authentication information A(K+1) that the control device 3 has been unable to receive (ST224). When the fraudulent unlock device 100 acquires the authentication information A(K+1), the fraudulent unlock device 100 immediately retransmits the authentication information A(K) acquired in step ST212 to the control device 3 (ST230).

When the fraudulent unlock device 100 retransmits the fraudulently acquired authentication information A(K), the interference waves is output from the transmission unit 21 of the transmission device 2 (ST226 and ST230). Therefore, the control device 3 fails in reception of the retransmitted authentication information A(K) from the fraudulent unlock device 100 (ST228). Since the control device 3 cannot receive either the authentication information transmitted from the transmission device 2 or the authentication information retransmitted from the fraudulent unlock device 100, an operation of locking or unlocking of the door lock device 6 is not executed. The user recognizes an abnormal state since locking or unlocking of the door lock device 6 is not executed even though a predetermined operation is performed in the operation input device 22 of the transmission device 2.

As described above, in the case of fraudulently acquiring the authentication information while interfering with the reception in the control device 3, the fraudulently acquired authentication information has not been yet received in the control device 3. Accordingly, it is possible to pass the authentication in the control device 3 by retransmitting the fraudulently acquired authentication information to the control device 3 (FIGS. 3 and 4). Therefore, in the case of fraudulently acquiring a plurality of pieces of authentication information continuously transmitted from the transmission unit 21 of the transmission device 2 while interfering with the reception in the control device 3, if first authentication information in the plurality of fraudulently acquired pieces of authentication information is retransmitted to the control device 3 (FIG. 3 and ST124), the authentication is passed using the retransmitted authentication information in the control device 3, and it is difficult for the fraudulent acquisition of the authentication information to be found.

According to this embodiment, since the interference waves interfere with the reception of the authentication information in the control device 3 in a period of at least a portion of an interval period from transmission of authentication information to next transmission of authentication information, it is difficult for the authentication information retransmitted after the fraudulent acquisition to be received in the control device 3 (ST226 to ST230 in FIG. 5). Accordingly, the authentication in the control device 3 is not passed even though a plurality of pieces of authentication information are transmitted, and the user can easily recognize an abnormal state. Thus, it is possible to easily discover the fraudulent acquisition of the authentication information.

Further, according to this embodiment, since the interference waves are output from the transmission unit 21 in at least one of a certain period before the authentication information is transmitted and a certain period after the authentication information is transmitted, it is possible to reduce normal power consumption, unlike a case where an output period of the interference waves is not limited.

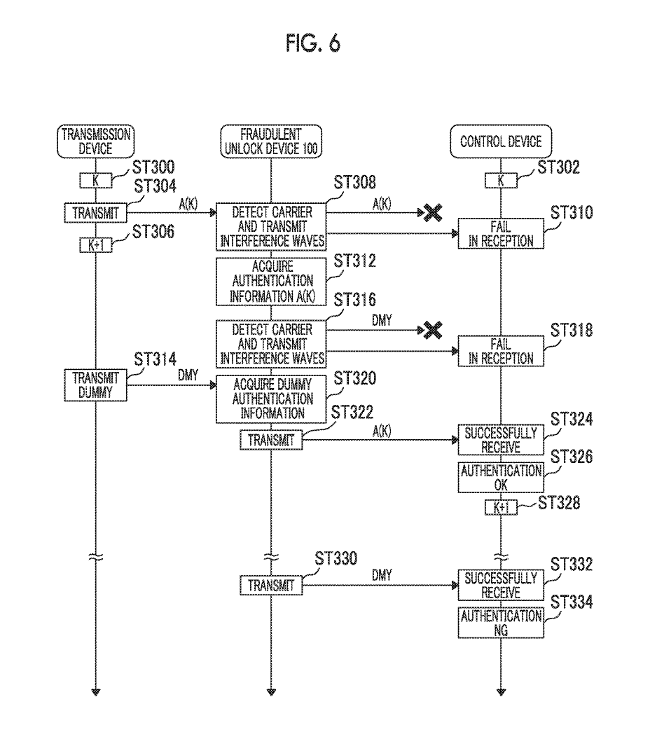

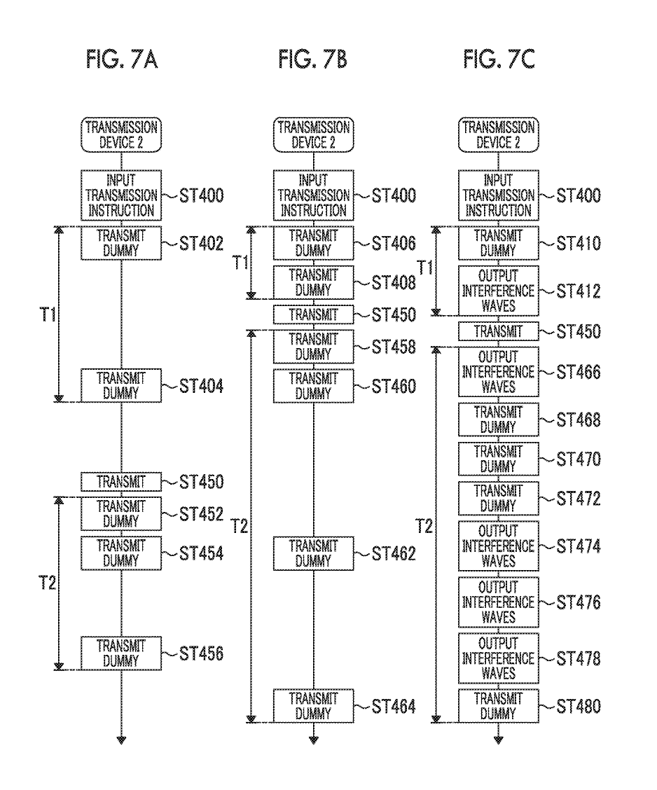

Next, a modification example of the transmission device 2 according to this embodiment will be described with reference to FIGS. 6 and 7.

FIG. 6 is a diagram illustrating a modification example of the operation in a case where authentication information is transmitted from a transmission device in a communication system according to an embodiment of the present invention.

In the modification example illustrated in FIG. 6, the control unit 203 of the transmission device 2 transmits the dummy authentication information DMY as a type of interference waves from the transmission unit 21. The dummy authentication information DMY is information that can be received as the authentication information in the control device 3 which is an authentication request destination and that is determined not to be legitimate in the control device 3. The control unit 203 transmits this dummy authentication information DMY from the transmission unit 21 in a period of at least a portion of an interval period from transmission of one piece of authentication information to transmission of next authentication information.

First, both the transmission-side code selection unit 201 and the reception-side code selection unit 302 select the code “K” (ST300 and ST202). In this state, the transmission device 2 transmits the authentication information A(K) (ST304). The transmission-side code selection unit 201 changes a selection target code from “K” to “K+1” (ST306).

When the fraudulent unlock device 100 detects that the authentication information is transmitted from the transmission device 2 using a carrier or the like of a transmission signal, the fraudulent unlock device 100 outputs interference waves W toward the control device 3 (ST308). Accordingly, the control device 3 fails reception of the authentication information A(K) (ST310). The fraudulent unlock device 100 removes the interference waves W using a band-pass filter or the like and acquires the authentication information A(K) (ST312).

The control unit 203 outputs the dummy authentication information DMY from the transmission unit 21 in an interval period until next authentication information A(K+1) is transmitted after the authentication information A(K) is transmitted from the transmission unit 21 in step ST204 (ST314).

When the fraudulent unlock device 100 detects that the dummy authentication information DMY is transmitted from the transmission device 2 using a carrier or the like of a transmission signal, the fraudulent unlock device 100 outputs interference waves W toward the control device 3 (ST316). Accordingly, the control device 3 fails reception of the dummy authentication information DMY (ST318). The fraudulent unlock device 100 removes the interference waves W using a band-pass filter or the like and acquires the dummy authentication information DMY (ST320). When the fraudulent unlock device 100 acquires the dummy authentication information DMY, the fraudulent unlock device 100 immediately retransmits the authentication information A(K) acquired in step ST312 to the control device 3 (ST322). At this time, since the fraudulent unlock device 100 does not output the interference waves, the control device successfully receives the authentication information A(K) (ST324). Since the authentication information A(K) acquired in step ST312 includes the code “K” and the code “K” matches the code “K” that is being selected in the control device 3, the control device 3 determines that the authentication information A(K) is legitimate (ST326). Accordingly, the control device 3 executes predetermined control such as door unlocking. The control device selects the next code “K+1” by authenticating the authentication information A including the code “K” (ST328).

Then, the fraudulent unlock device 100 retransmits the dummy authentication information DMY acquired in step ST320 to the control device 3 (ST330). The control device 3 normally receives the retransmitted dummy authentication information DMY (ST332). The determination unit 301 of the control device 3 determines that the received dummy authentication information DMY is not legitimate since the received dummy authentication information DMY is not regular authentication information (ST334).

As described above, since the authentication of the control device 3 cannot be passed with the dummy authentication information even when the dummy authentication information DMY is fraudulently acquired by the fraudulent unlock device 100, it is possible to enhance security. Further, since it is difficult for the authentication information retransmitted after fraudulent acquisition to be received by the control device 3 by the dummy authentication information DMY transmitted in an interval period from transmission of one piece of authentication information to transmission of next authentication information functioning as interference waves, it is possible to easily discover the fraudulent acquisition of the authentication information.

FIGS. 7A to 7C are diagrams illustrating another modification example of the operation in a case where the authentication information is transmitted from the transmission device 2.

In the modification example illustrated in FIG. 7, the control unit 203 of the transmission device 2 changes, in each interval period, at least one of the number of transmissions, a transmission interval, and a transmission period of the dummy authentication information in an interval period from transmission of one piece of authentication information to transmission of next authentication information. The control unit 203, for example, performs this change at random.

A reference sign “T1” in FIGS. 7A to 7C indicates a period in which the dummy authentication information or interference waves are transmitted from the transmission unit 21 in an interval period before the transmission of authentication information is performed in the transmission unit 21 (ST450). This period T1 is set by the control unit 203 after an operation for instructing execution of the transmission is performed in the operation input device 22 (ST400). Further, a reference sign “T2” in FIGS. 7A to 7C indicates a period in which the dummy authentication information or interference waves are transmitted from the transmission unit 21 in an interval period after the transmission of the authentication information is performed in the transmission unit 21 (ST450). This period T2 is set by the control unit 203 after the transmission of the authentication information is performed in the transmission unit 21.

In the example of FIG. 7A, the control unit 203 performs two transmissions of the dummy authentication information in the period T1 (ST402 and ST404), and performs three transmissions of the dummy authentication information in the period T2 (ST452, ST454, and ST456).

Further, in the example of FIG. 7B, the control unit 203 performs two transmissions of the dummy authentication information in the period T1 (ST406 and ST408), and performs four transmissions of the dummy authentication information in the period T2 (ST458, ST460, ST462, and ST464).

Further, in the example of FIG. 7C, the control unit 203 performs one transmission of the dummy authentication information (ST 410) and one output of the interference waves (ST 412) in the period T1 and performs four transmissions of the dummy authentication information (ST468, ST470, ST472, and ST480) and four outputs of the interference waves (ST466, ST474, ST476, and ST478) in the period T2.

The control unit 203 changes lengths of the periods T1 and T2, and the number of transmissions of dummy authentication information and the interference waves and a transmission interval of the dummy authentication information and the interference waves in the periods T1 and T2 at random.

Thus, since it is difficult to distinguish between regular authentication information and the dummy authentication information by randomly changing the number of transmissions of the dummy authentication information (interference waves), the transmission interval, and transmission period at the interval from transmission of one piece of authentication information to transmission of next authentication information, the dummy authentication information is fraudulently acquired in place of the regular authentication information, and a probability of retransmission becomes high. Further, since it is difficult to retransmit the fraudulently acquired authentication information by avoiding the transmission timing of the dummy authentication information (interference waves) from the transmission device 2, it is difficult for the fraudulently acquired authentication information to be received in the control device 3. Thus, since it is easy for a state in which the authentication is not passed in the control device 3 to continue and the user can easily recognize an abnormal state, it is possible to easily discover the fraudulent acquisition of the authentication information.

Although the embodiments of the present invention have been described above, the present invention is not limited to the above embodiments and includes various other variations.

The above-described embodiments show examples of the present invention applied to a keyless entry system, but the present invention is not limited to the examples. That is, the present invention is widely applicable to a communication system in which a control device installed in a vehicle, a machine device, house equipment, or the like other than a car performs various controls on the basis of wireless communication with an authenticated transmission device.

1. A transmission device that wirelessly transmits authentication information including a code for authentication to an authentication request destination, the transmission device comprising:
a transmission-side code selection unit configured to sequentially select one code from a predetermined code sequence each time the authentication information is to be transmitted;
an authentication information generation unit configured to sequentially generate the authentication information including the one code that is being selected in the transmission-side code selection unit;
a transmission unit configured to sequentially transmit the generated authentication information including the one code, correspondingly to the sequential selection of the one code from the predetermined code sequence; and
a control unit configured to control the transmission unit to output interference waves that interfere with reception of the authentication information at the authentication request destination for a time period of at least a portion of an interval between two successive transmissions of the authentication information.

2. The transmission device according to claim 1,
wherein the control unit controls the transmission unit to output the interference waves for at least one of a certain time period before the transmission of the authentication information and a certain time period after the transmission of the authentication information.

3. The transmission device according to claim 1,
wherein the control unit further controls the transmission unit to transmit dummy authentication information at least once in the interval between two successive transmissions of the authentication information, the dummy authentication information being received as the authentication information but determined to be not legitimate at the authentication request destination.

4. The transmission device according to claim 3,
wherein the control unit changes at least one of a number of transmissions, a transmission interval, and a transmission period of the dummy authentication information for each interval between two successive transmissions of the authentication information.

5. A communication system, comprising:
a transmission device configured to wirelessly transmit authentication information including a code for authentication; and
a control device configured to receive the authentication information and determine legitimacy of the received authentication information,
wherein the transmission device includes:
a transmission-side code selection unit configured to sequentially select one code from a predetermined code sequence each time the authentication information is to be transmitted;
an authentication information generation unit configured to sequentially generate the authentication information including the one code that is being selected in the transmission-side code selection unit;
a transmission unit configured to sequentially transmit the generated authentication information, correspondingly to the sequential selection of the one code from the predetermined code sequence; and
a control unit configured to control the transmission unit to output interference waves that interfere with reception of the authentication information at the control device for a time period of at least a portion of an interval between two successive transmissions of the authentication information.

6. A method for wirelessly transmitting authentication information including a code for authentication from a transmission device to an authentication request destination, the method comprising:
sequentially selecting one code from a predetermined code sequence each time the authentication information is to be transmitted;
sequentially generating the authentication information including the one code that is being selected;
sequentially transmitting the generated authentication information, correspondingly to the sequential selection of the one code from the predetermined code sequence; and
transmitting interference waves that interfere with reception of the authentication information at the authentication request destination for a time period of at least a portion of an interval between two successive transmissions of the authentication information.

7. The transmission device according to claim 1,
wherein the control unit further controls the transmission unit to transmit dummy authentication information at least once before and after the transmission of the authentication information, the dummy authentication information being received as the authentication information but determined to be not legitimate at the authentication request destination.

8. The transmission device according to claim 7,
wherein the control unit changes at least one of a number of transmissions, a transmission interval, and a transmission period of the dummy authentication information for each time period before and after the transmission of the authentication information.
